(19) United States
(12) Patent Application Publication
(10) Pub. No.: US 2002/0123926 A1
(43) Pub. Date: Sep. 5, 2002

(54) System and method for implementing a loyalty program incorporating on-line and off-line transactions

(76) Inventors: Thomas R. Bushold, Fenton, MO (US); Mark A. Shipley, Fenton, MO (US)

Correspondence Address: SENNIGER POWERS LEAVITT AND ROEDEL, ONE METROPOLITAN SQUARE, 16TH FLOOR, ST LOUIS, MO, 63102, US

(21) Appl. No.: 09/797,189

(22) Filed: Mar. 1, 2001

(51) Int. Cl. G06F 17/60

(52) U.S. Cl. 705/14

(57) ABSTRACT

A system and method for implementing a loyalty program. Each program has a client providing products and/or services to customers. The client desires to build loyalty relationships with the customers. The customers complete on-line and off-line transactions or behaviors with the client. The program receives information relating to the on-line and off-line transactions or behaviors and issues reward points redeemable for rewards to the customers on the basis of the received information.

### BACKGROUND OF THE INVENTION

1. Field of the Invention

The present invention relates to the field of loyalty programs. In particular, this invention relates to a method and system for implementing a loyalty program which incorporates on-line electronic and off-line point-of-sale transactions of the customers.

2. Description of the Prior Art

Loyalty programs or loyalty/frequency marketing programs focus on customers who consume or purchase products and/or services from a client. For example, the customers include consumers and businesses. The client is the vendor of the products and/or services and funds the loyalty program. A typical loyalty program operates for multiple years and includes a large number of customers. After enrolling in the loyalty programs, customers earn reward points redeemable for rewards or are selectively targeted with communications in order to drive desired behavior. For example, a typical loyalty program may involve the customer purchasing an item at a point-of-sale location such as a local store of the client. The customer earns reward points for the purchase. The client sends a description of the purchased item and/or the amount of the earned reward points to a centralized loyalty database. Once the customer accumulates a predetermined amount of reward points, the customer is eligible to redeem the reward points for rewards.

For more information relating to gathering point-of-sale transactions, refer to: CENTRALIZED CONSUMER CASH VALUE ACCUMULATION SYSTEM FOR MULTIPLE MERCHANTS, U.S. Pat. No. 5,202,826 by McCarthy, incorporated herein by reference.

As used herein, the loyalty program differs from an incentive program although these programs may overlap and, in the past, the terms “loyalty” and “incentive” have been used in various ways. Incentive programs focus on participants who sell, distribute, or refer products and services of the client. The participants include employees, distributors, partners, etc. For example, in a typical incentive program, an employer identifies goals for each employee (participant) in the sales department. The employer also selects awards to be given to the participants when the participants achieve their designated goals.

There is a need for a system which gathers the on-line and off-line transactions of the customer for use by a loyalty program. There is also a need for a system which implements a computerized loyalty program using any computer language. There is also a need for a system which implements a loyalty program which interfaces with additional systems via batch files. There is also a need for a system which implements a loyalty program which receives redemption requests and forwards the requests to be fulfilled by a third party fulfillment system.

### SUMMARY OF THE INVENTION

It is an object of this invention to provide a method and system which gathers the on-line and off-line transactions of the customer for use by a loyalty program.

It is an object of this invention to provide a method and system which implements a computerized loyalty program using any computer language.

It is an object of this invention to provide a method and system which implements a loyalty program which interfaces with additional systems via batch files.

It is an object of this invention to provide a method and system which implements a loyalty program which receives redemption requests and forwards the requests to be fulfilled by a third party fulfillment system.

In one form, the invention includes a system for implementing a loyalty program. Each program has a client providing products and/or services. Each program has reward points redeemable for rewards. Each client has at least one customer with which the client desires to build a loyalty relationship. The system comprises an electronic transaction gathering system, an interface to a point-ofsale (POS) transaction gathering system, an issuance system, a database, and a redemption request system. The electronic transaction gathering system gathers electronic information relating to electronic transactions between the client and the customer. The POS transaction gathering system gathers POS information relating to POS transactions between the client and the customer. The issuance system issues the reward points to the customer in response to the gathered electronic and POS information. The database stores the gathered electronic and POS information and an amount of the issued reward points of each customer. The redemption request system allows the customer to request redemption of the reward points for rewards.

In another form, the invention includes a method for implementing a loyalty program. Each program has a client providing products and/or services. Each program has reward points redeemable for rewards. Each client has at least one customer with which the client desires to build a loyalty relationship. The method comprises the steps of:

gathering electronic information relating to electronic transactions between the client and the customer;

gathering POS information relating to POS transactions between the client and the customer;

issuing the reward points to the customer in response to the gathered electronic and POS information;

storing the gathered electronic and POS information and an amount of the issued reward points of each customer; and

allowing the customer to request redemption of the reward points for rewards.

In another form, the invention includes a system for implementing a loyalty program. Each program has a client providing products and/or services. Each program has reward points redeemable for rewards. Each client has at least one customer with which the client desires to build a loyalty relationship. The system comprises means for gathering electronic information relating to electronic transactions between the client and the customer. The system further comprises means for gathering POS information relating to POS transactions between the client and the customer. The system further comprises means for issuing the reward points to the customer in response to the gathered electronic information of said means for gathering electronic information and in response to the gathered POS information of said means for gathering POS information. The system further comprises means for storing the gathered electronic and POS information and an amount of the issued reward points of each customer. The system further comprises means for allowing the customer to request redemption of the reward points for rewards.

In another form, the invention includes a method for implementing a loyalty program. Each program has a client providing products and/or services. Each client also has one or more customers with which the client desires to build a loyalty relationship. The method comprises the steps of:

gathering electronic information relating to electronic transactions between the client and the one or more customers;

gathering POS information relating to POS transactions between the client and the one or more customers;

storing the gathered electronic and POS information; and

identifying at least one specific customer from the one or more customers based on one or more criteria involving the gathered electronic information relating to electronic transactions between the client and the specific customer and the gathered POS information relating to POS transactions between the client and the specific customer.

Other objects and features will be in part apparent and in part pointed out hereinafter.

### BRIEF DESCRIPTION OF THE DRAWINGS

FIG. 1 is a block diagram of a preferred embodiment of the method and system of the invention illustrating the components of the system.

FIG. 2 is a block diagram of a preferred embodiment of the method and system of the invention illustrating optional components of the system.

FIG. 3 is a flow chart of one embodiment of the method and system of the invention illustrating operation.

FIG. 4 is a block diagram of a preferred embodiment of the method and system of the invention illustrating operation where the transactions are retail purchases.

Corresponding reference characters indicate corresponding parts throughout the drawings.

### DETAILED DESCRIPTION OF PREFERRED EMBODIMENTS

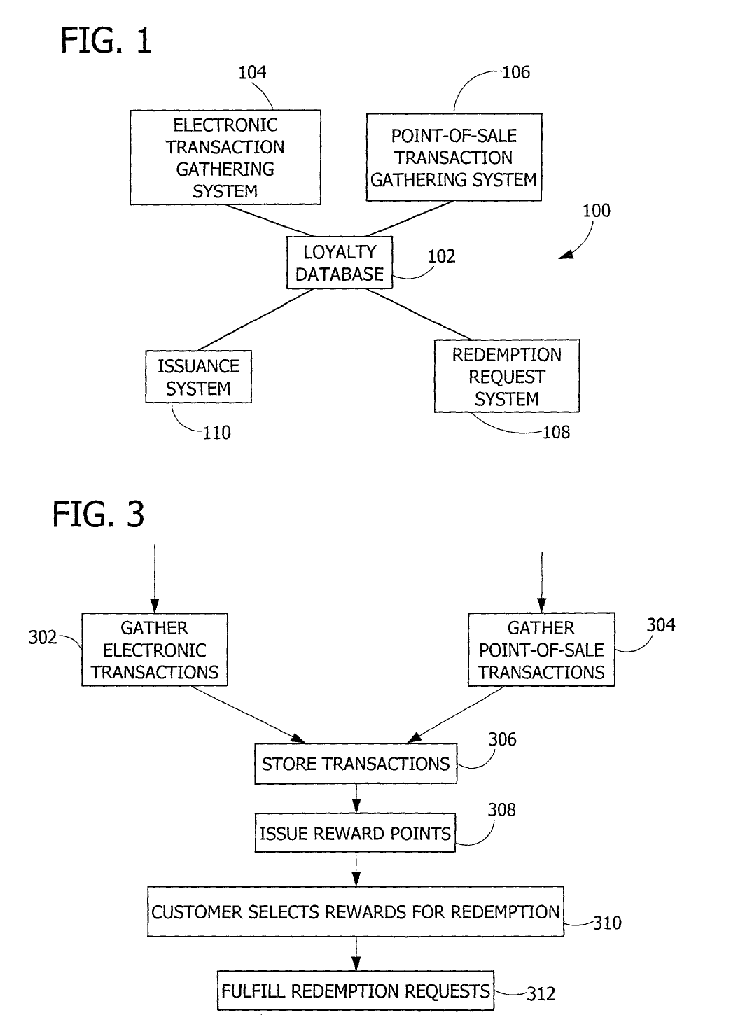

Referring first to FIG. 1, a block diagram illustrates the main components of the invention. In general, the invention is a method and system (hereinafter referred to as “system 100”) for implementing a loyalty program or loyalty marketing program (hereinafter “program”) for a client. Each program allows the client to build a loyalty relationship or otherwise encourage desired behavior from at least one customer of the client by awarding reward points to the customers in response to specific transactions of the customers. The reward points of each customer are stored in reward point accounts 204 associated with each customer. The client selects rewards to be available to the customers for redemption. The customers select rewards and redeem the reward points for the rewards. The client is often a company offering products and/or services. The customer of the client is a consumer of the client's products and/or services. A supplier provides the system 100.

An electronic transaction gathering system 104, a point-of-sale (POS) transaction gathering system 106, an issuance system 110, and a redemption request system 108 interface with a loyalty database 102. The electronic transaction gathering system 104 gathers electronic information relating to electronic transactions of the customer in approximate real-time. The electronic information for a specific electronic transaction includes, but is not limited to, a time, date, and electronic transaction identification number associated with the specific electronic transaction. The electronic transactions include, but are not limited to, completing an on-line purchase, selecting a banner advertisement, transmitting an email, referring a friend for enrollment, or completing an on-line survey. The on-line purchase occurs over a global computer network such as the Internet, or other network. For example, the electronic transaction gathering system 104 may constitute software for monitoring on-line transactions. The electronic transaction gathering system 104 captures the electronic transactions and transmits the captured transactions (i.e., the electronic information) to the loyalty database 102 for storage. The POS transaction gathering system 106 gathers POS information relating to POS transactions of the customer. The system 100 includes an interface to the POS transaction gathering system 106 to receive and store the POS information in the loyalty database 102. In one embodiment, the POS transaction gathering system 106 is associated with the client and is a business machine such as a cash register. Alternatively, the POS transaction gathering system 106 may constitute software monitoring credit card transactions at a particular location. The POS information for a specific POS transaction includes, but is not limited to, a time, date, and POS transaction identification number associated with the specific POS transaction. The POS transactions include, but are not limited to, completing a retail purchase at a local store, referring a friend for enrollment in the program, or completing a survey. In an alternative embodiment, the gathered transactions include any event caused by the customer, including achieving an anniversary date or having a birthday.

The POS transaction gathering system 106 captures the POS transactions and transmits the captured transactions (i.e., the POS information) to the interface. The interface to the POS transaction gathering system 106 receives the captured transactions from the POS transaction gathering system 106 and stores the captured transactions in the loyalty database 102. The loyalty database 102 stores the gathered electronic and POS transactions. In one embodiment, the gathered transactions are entered into the loyalty database 102 by a human operator employing a personal computer or other input device to act as the interface between the gathered transactions and the loyalty database 102. The loyalty database 102 also stores an amount of the issued reward points of each customer. The issuance system 110 issues the reward points to the customer in response to the gathered electronic and POS transactions. The issuance system 110 issues the reward points according to an allocation designated by the client. In one embodiment, the client designates an allocation by allocating the reward points to the customers according to any method associated with the client. The allocation is transferred to the issuance system 110 by the client. The issuance system 110 then issues the allocated amount of the reward points to each customer as designated by the client. The redemption request system 108 allows the customer to request redemption of the reward points for the rewards. The customer accesses the redemption request system 108 via a network or a telecommunications device. The telecommunications device includes, but is not limited to, a standard telephone, cellular telephone, personal computer, personal digital assistant, or a processor connected to a modem with facsimile or electronic mail capability. The network includes, but is not limited to, a global computer network such as the Internet, a wide area network, a local area network, an intranet, or a wireless network. The redemption request system 108 includes a port for allowing the customers to access the redemption request system 108 via the telecommunications device. The port is any input/output device or software program facilitating access to the redemption request system 108. In one embodiment where the redemption request system 108 is accessible from a website, the port includes the computer server and software providing access to the website.

A delay is associated with one or more of the capture, transmission, and issuance functions associated with the electronic transaction gathering system 104 and the issuance system 110 as described herein. Similarly, a delay is associated with one or more of the capture, transmission, and issuance functions associated with the POS transaction gathering system 106 and the issuance system 110 as described herein. For example, the capture and transmission for the electronic transaction gathering system 104 may occur in near real-time, while the issuance may occur daily. Similarly, in another embodiment, the capture and transmission for the POS transaction gathering system 106 may occur on a batch basis (e.g., nightly) while the issuance system 110 may issue award points immediately after receiving the batched transactions.

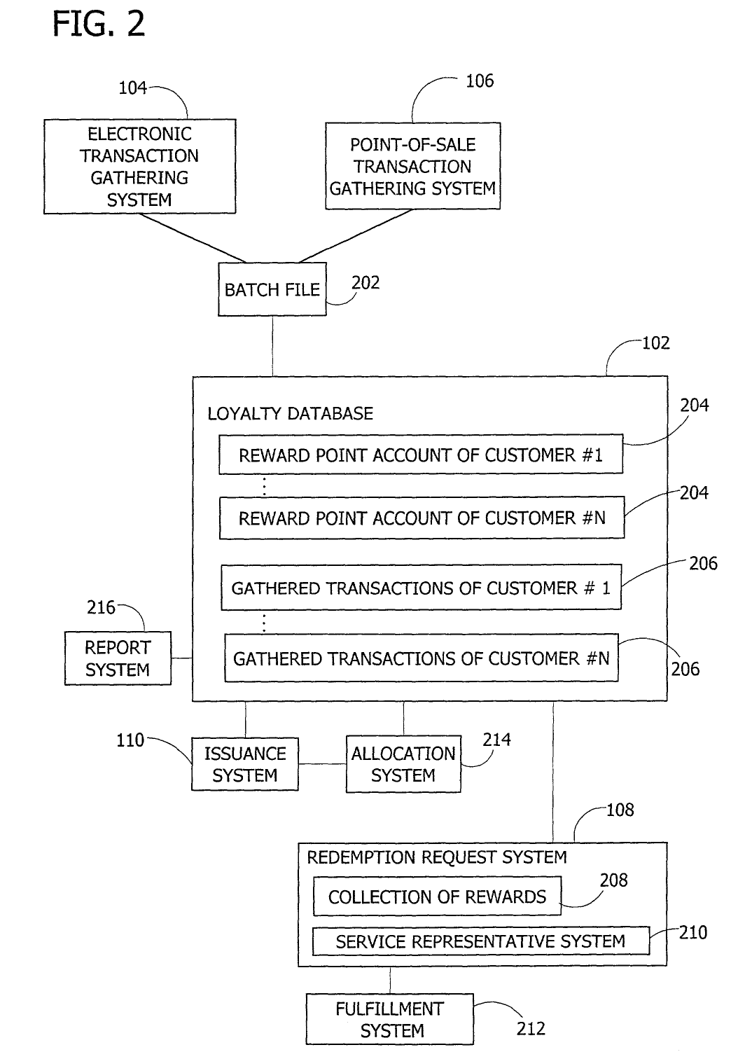

Referring next to FIG. 2, a block diagram illustrates optional components of the system 100. One or more batch files 202 contain the gathered electronic transactions from the electronic transaction gathering system 104 and the gathered POS transactions from the POS transaction gathering system 106. The batch file 202 is input into the loyalty database 102, preferably via a processor accessing the batch file 202 and the loyalty database 102. In one embodiment, the batch files 202 are text files in ASCII format. The loyalty database 102 stores the gathered electronic and POS transactions 206 of each customer, from customer #1 to customer #N where there are N customers enrolled in the program. The loyalty database 102 also stores the reward point accounts 204 of each customer, from customer #1 to customer #N. In addition, the loyalty database 102 includes data cleansing functions and allows ongoing updates to a list of enrolled customers.

Those skilled in the art will note that the loyalty database 102 can be organized in a number of different ways not specifically detailed herein. For example, the loyalty databases 102 of the clients may each reside on a separate computer server. Alternatively, a single computer server may contain the loyalty databases 102 of several clients. However, each loyalty database 102 only contains information relating to a specific client. A single record for each customer within the loyalty database 102 may contain the gathered transactions and reward point accounts 204 associated with that customer. Alternatively, all the reward point accounts 204 of the customers may be stored in one area of the loyalty database 102, while the gathered transactions may be stored in another area of the loyalty database 102 or another loyalty database 102 entirely. In one embodiment, the loyalty database 102 is a relational database.

An allocation system 214 accesses the gathered transactions in the loyalty database 102. The allocation system 214 allocates an amount of the reward points to each customer according to business rules defined by the client. The business rules or other rules structures or payout structures define the manner in which rewards are earned by the customers. The clients select or create the business rules to reflect the individual needs of the client. In one embodiment, the business rules define one or more methods for awarding the reward points to the customers. The business rules include primary, secondary, and bonus methods. For example, the customers earn reward points according to the primary method by interacting directly with the client. The customers also earn reward points according to the secondary method by interacting with affiliated partners of the client. The customers also earn reward points according to the bonus method during promotions offered by the client or its affiliated partners. The business rules also allow the client to adjust a point-to-dollar ratio representing the number of the reward points per monetary currency. For example, the point-to-dollar ratio may be one point for every dollar spent by the customer. To implement the loyalty program for a specific client, the supplier applies the business rules and other modifications specified by the client to a generic loyalty program framework to create the loyalty program for that client. The generic loyalty program framework contains the specific client preferences such as the rewards available for redemption, a graphic design, and the business rules.

The allocation system 214 applies the business rules to the gathered transactions to obtain the allocation of reward points for each customer. The issuance system 110 interfaces with the allocation system 214 to access the allocation of the reward points for each customer. The issuance system 110 then issues the allocated amount of the reward points to each customer. The issuance system 110 accesses the loyalty database 102 to have the reward point accounts 204 of the customers incremented according to the reward point allocation.

The customers access the redemption request system 108 to request redemption of their reward points for the rewards. The redemption request system 108 includes a collection of rewards 208 from which each client selects the rewards to be available to that client's customers for redemption. The collection of rewards 208 includes merchandise, individual travel, gift certificates, charities, client products or services (in-kind rewards), partner products or services, or special featured offers. The collection of rewards 208 also includes “hard” awards such as merchandise and “soft” rewards such as a toll-free telephone number to call for service. The customers of a specific client only see those rewards selected by that client to be available for redemption. Additionally, specific customer segments of a specific client will only see specific rewards selected by the client to be available for redemption. In a points-based program, each reward is assigned a value which represents an amount of the reward points which are required to redeem the reward. In one embodiment, each reward can be assigned multiple values so that various amounts of reward points are required to redeem the reward in different programs or by different customers. For example, one reward may require 10 points to redeem in one program while the same reward may require 20 points to redeem in another program.

The redemption request system 108 includes a shopping cart. The shopping cart allows the customer to select rewards for purchase and view the financial impact of the selection updated in real-time. As the customer browses the available rewards, the customer selects the rewards to be added or deleted from the shopping cart. Detailed information about the selected rewards is also communicated to the customer. Preferably, information associated with the selected rewards is displayed visually to the customer. The redemption request system 108 interfaces with the loyalty database 102 to obtain the amount of the reward points available to the customers. Customers are allowed to view all rewards that are available for redemption, but are only able to redeem rewards for which the customer has earned sufficient reward points to redeem. If sufficient reward points exist, then the system 100 allows the customer to generate the redemption request.

The redemption request system 108 also includes a service representative system 210 for allowing a service representative to access the redemption request system 108 on behalf of each customer. The service representative system 210 allows the customers who cannot directly access the redemption request system 108 to generate redemption requests. The customer interacts with the service representative via the network or telecommunications device as described above. Alternatively, the customer interacts with the service representative by visiting a bricks-and-mortar, client store in person. The service representative verifies the identity of the customer by asking the customer to provide information specific to the customer, such as an address or telephone number. The service representative generates redemption requests and performs other operations available to the specific customer within the redemption request system 108 by accessing the loyalty database 102 for the customer. In addition, at the request of the customer, the service representative can transfer the reward points of the customer to and from various reward point accounts 204. The service representative reviews bulletins, special offers, or other information while the customer is interacting with the service representative. The list of FAQs is available to the service representative to answer questions asked by the customer.

Through the redemption request system 108, the customers generate the redemption requests to redeem the reward points for the available rewards. A third party fulfillment system 212 receives the redemption requests from the redemption request system 108 and fulfills the requests. The fulfillment system 212 includes reward partners to supply and deliver the rewards. A third party independent of the supplier provides the fulfillment system 212 to fulfill the redemption requests received from the redemption request system 108. For example, the fulfillment system 212 may constitute a warehouse that stores and ships the rewards responsive to the redemption requests received from the redemption request system 108.

A report system 216 accesses the loyalty database 102 to produce reports relating to the gathered transactions and requested redemptions. Through the report system 216, the supplier (i.e., the loyalty program provider) or the client generates reports indicating program activity for each program of the client or customer activity for each customer of the client. The reports include, but are not limited to, management summary reports and individual customer reports. The management summary reports indicate the program activity for each program of the client. The individual customer reports indicate the customer activity for each customer of the client. The program activity includes, but is not limited to, redemption requests, customer enrollment in the program, customer removal from the program, specific rewards redeemed, gathered electronic transactions, and gathered POS transactions. The reports are generated and delivered to the client electronically or in paper form, as requested by the client. The reports are generated manually by the supplier or the client or are automatically generated by the system 100. The client selects the frequency of automatic report generation. In this manner, the system 100 facilitates customer behavior tracking by providing database evaluation and scoring, customer modeling and profiling, recency/frequency/monetary trending, segments evaluations, ongoing performance tracking, and return-on-investment analyses.

Similarly, in an alternative embodiment, each customer generates reports through the report system 216 indicating the customer activity of that customer. The customer activity includes, but is not limited to, a redemption history, specific rewards redeemed, gathered electronic transactions, and gathered POS transactions. The redemption history details the redemption requests generated by the customer. The gathered transactions identify the specific transactions which have been entered into the loyalty database 102. The reports are generated and delivered to the customer electronically or in paper form. The reports are generated manually by the customer or automatically by the system 100. The customer selects the frequency of automatic report generation.

The reports generated by the report system 216 include standardized reports and customized marketing analysis. For example, the reports are generated weekly and monthly and include point activity such as points earned, points redeemed, points expired, and bonus point activity. The reports also include purchase and transaction history such as month to month customer behavior trending. Further, the report system 216 include customer service operational reports such as automatic call distributor reports and call disposition reports. The report system 216 also details reward fulfillment including reports on redemption, redemption by segment, reward inventory, returned rewards, and pending or back ordered rewards. General program reports are used to audit monthly invoices. Quarterly marketing analyses include specific client requirements and customer segmentation.

Referring next to FIG. 3, a flow chart illustrates operation of the program. The system 100 gathers at 302, 304 electronic and POS transactions. The system 100 then stores at 306 the gathered transactions and issues at 308 the reward points based on the gathered transactions. The issued reward points for each customer are stored in the loyalty database 102. The client browses the collection of rewards 208 and selects at 310 the rewards to be available to the customers of that client. The customer generates the redemption requests by selecting the rewards for redemption. A third party system then fulfills at 312 the redemption requests.

There are several alternative embodiments of the system 100. The functions of the electronic transaction gathering system 104 and the POS transaction gathering system 106 are performed partially or entirely by the client. The client gathers electronic transactions and/or POS transactions to create the batch file 202 to be sent to the supplier for entry into the loyalty database 102. In one embodiment, the client awards the reward points to the customers at-will or in response to any transaction or occasion. The system 100 includes a graphic design presenting communications to the customers electronically or in paper form. The graphic design is visible when the customers access the redemption request system 108, and includes, but is not limited to, elements such as a program home page, theme, graphics, text, banner advertisements, and rewards photography. The graphic design is customizable by request of the client for each program of the client to match a brand image/design of the client. The graphic design is also visible to the customers in an enrollment solicitation, a welcome kit, a newsletter, or in the reports generated by the report system 216. In one embodiment, the redemption request system 108 is branded to the client to reflect the graphic design of the client.

In one embodiment, the client accesses all the components of the system 100 via the network. The customer accesses the redemption request system 108 and the report system 216 via the network.

In another embodiment, the client specifies the manner in which the issued reward points expire, reducing the amount of the reward points of each customer accordingly. The expiration may be time-based or event-based. In one embodiment, the reward points expire according to at least one method (e.g., the reward points expire at different times). The redemption request system 108 includes a list of frequently-asked questions (FAQ) and answers for review by the customer. In one embodiment, the customer reviews program rules or other terms and conditions via the redemption request system 108 or via a toll-free telephone number. After generating the redemption request, the customers receives shipping information including, but not limited to, a unique order number, a tracking number, and order status. The shipping information is available electronically. In an alternative embodiment, the shipping information is delivered to the customer in paper form. During operation of the program, the client or supplier modifies aspects of the program including, but not limited to, the graphic design, earning opportunities, point values, the rewards available to the customers for redemption, or the business rules.

In another embodiment, the client or other entity paying the supplier for access to the loyalty database 102 queries the loyalty database 102 to target customers to receive communications. An example of such an embodiment that does not use reward points includes a one-to-one communications program that enables clients to identify, communicate with, and add customers via a planned direct marketing schedule of targeted messages and offers. The loyalty database 102 stores transaction information such as purchases associated with the customer. Querying or mining the loyalty database 102 includes searching the loyalty database 102 to obtain names, addresses, telephone numbers, or other identification means of various customers based on search criteria input by the client or supplier. The search criteria reflects the goals of the client. The loyalty database 102 can be divided into segments at program inception and can be modified during program operation. The client or supplier queries the database by categorizing the customers according to these segments. For example, the client may identify customers by creating segments to categorize the customers according to geography, purchasing patterns, products purchased, or any other data that is captured as part of the transaction or customer profile. The client then sends targeted communications to the identified (segmented) customers. The client-specific and/or customer-specific targeted communications are in print and/or email and include program enrollment and solicitation packages, program brochures, rewards catalogues, website information, and ongoing program promotions. The reports for the one-to-one communications program include weekly and monthly reports detailing all responses to the program.

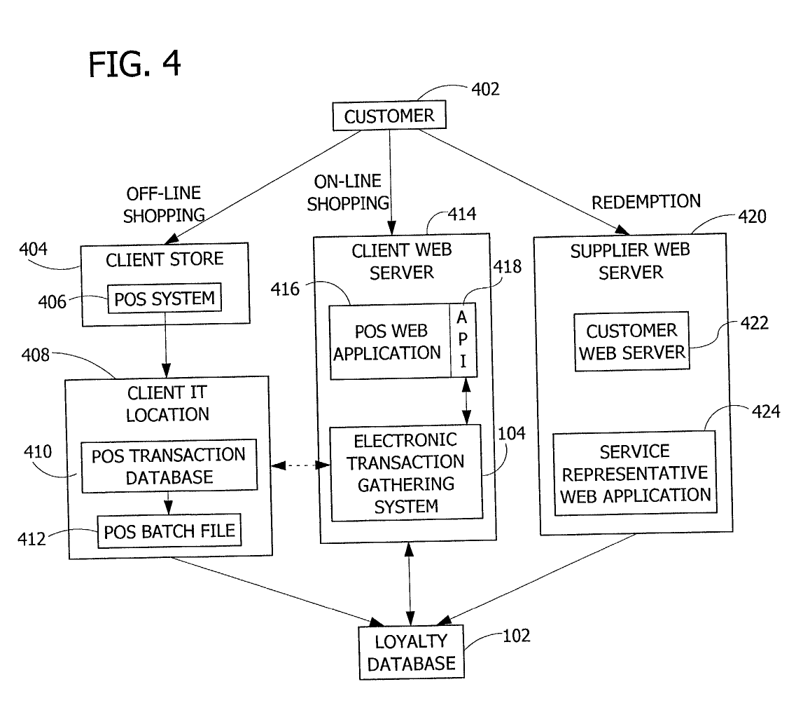

Referring next to FIG. 4, a block diagram shows operation of the program where the transactions are retail purchases. In this embodiment, the customer 402 shops off-line at the client store 404. The client store 404 includes a POS system 406 such as a cash register to gather or otherwise capture transactions such as retail purchases. The captured transactions are sent to a client information technology (IT) location 408 for storage in a POS transaction database 410. Those skilled in the art will note that the client IT location 408 may be onsite with the client store 404 or offsite from the client store 404 to store the captured transactions in the POS transaction database 410. A POS batch file 412 is created from the POS transaction database 410. The POS batch file 412 contains the gathered transactions for transmission to the loyalty database 102. An administrator, preferably associated with the client, creates the POS batch file 412 on a regular basis or manually as needed. The administrator transmits the POS batch file 412 to the loyalty database 102. In an alternative embodiment, a processor regularly accesses the POS transaction database 410, creates the POS batch file 412, and transmits the POS batch file 412 electronically to the loyalty database 102. Referring to FIGS. 1 and 4, the POS system 406 and the elements of the client IT location 408 in FIG. 4 relate to the POS transaction gathering system 106 in FIG. 1.

The customer 402 also shops on-line at a client web server 414. The client web server 414 includes a POS web application 416 created according to a specific application program interface (API) 418. In this embodiment, the POS web application 416 is a software program operating an electronic commerce website allowing the customer 402 to make on-line purchases. The API 418 includes a set of routines and/or protocols for creating software programs. The electronic transaction gathering system 104 utilizes the API 418 to electronically gather the on-line transactions of the customer 402. In one embodiment, the API 418 is written in Java or an Extensible Markup Language (XML). The electronic transaction gathering system 104 transmits the gathered transactions to the loyalty database 102 on a regular or manual basis through closed loop data transmission. The closed loop data transmission occurs over a global computer network such as the Internet or other network as described above. In one embodiment, the electronic transaction gathering system 104 operates in near real-time by capturing a specific transaction and immediately transmitting the captured transaction to the loyalty database 102. Later, the business rules are applied to the captured transactions to allocate and issue the reward points to the customer 402. The application of the business rules to the captured transactions occurs after a delay selected by the client. In one embodiment, the application occurs on a nightly basis for all the transactions captured during the day. In another embodiment, the application occurs at a selected interval such as once a month for all the transactions captured during the month.

The electronic transaction gathering system 104 also captures customer 402 enrollment data, generates account identification and personal identification numbers, and allows minor editing and/or updating. In an alternative embodiment, the electronic transaction gathering system 104 accesses the POS transaction database 410 at the client IT location 408 to obtain the POS transactions. The electronic transaction gathering system 104 transmits the POS transactions with the gathered electronic transactions to the loyalty database 102 for storage.

The customer 402 accesses a supplier web server 420 to redeem the reward points for rewards. In one embodiment, the supplier web server 420 is accessible to the customer 402 via a hypertext link from a website associated with the client. The supplier web server 420 includes a customer web application 422 and a service representative web application 424. The customer web application 422 is a website facilitating reward redemption by the customer 402. The service representative web application 424 is a website facilitating reward redemption by the service representative acting on behalf of the customer 402 (see FIG. 2 above). The supplier web server 420 accesses the loyalty database 102 to obtain information including, but not limited to, the amount of the reward points of the customer 402 and the redemption history of the customer 402. The customer web application 422 and the service representative web application 424 access the same loyalty database 102. Referring to FIGS. 1 and 4, the supplier web server 420 in FIG. 4 relates to the redemption request system 108 in FIG. 1.

The electronic transaction gathering system 104 operates by capturing and transmitting the electronic information to the loyalty database 102 for future processing. In one embodiment, all transactions by the customers 402 are captured and transmitted to the loyalty database 102. When the customer 402 makes an on-line transaction such as a purchase, the customer 402 presents a unique customer identifier such as an account number to the client web server 414. The electronic transaction gathering system 104, provided by the supplier and resident at the client web server 414, then creates the batch file 202 containing the customer identifier and the electronic information for the transaction. In one embodiment, the electronic transaction gathering system 104 immediately transmits the batch file 202 to the loyalty database 102 for future processing. After a processing delay at the loyalty database 102, the system 100 applies the business rules to the captured, received transactions to allocate and issue the reward points.

Similarly, the POS transaction gathering system 106 operates by capturing and transmitting the POS information to the loyalty database 102 for future processing. In one embodiment, all transactions by the customers 402 are captured and transmitted to the loyalty database 102. When the customer 402 makes a transaction such as a purchase, the customer 402 presents the customer identifier at the client store 404. The methods for presenting the customer identifier include, but are not limited to, scanning a bar code representing the account number on a membership card, and entering the unique identifier directly into the POS system 406 via the customer 402 or a clerk associated with the client. The POS transaction gathering system 106 then creates the batch file 202 containing the customer identifier and the POS information for the transaction. After an adjustable transmission delay, the batch file 202 is transmitted to the loyalty database 102 for future processing. The client and/or supplier selects the transmission delay. The transmission delay period typically ranges from several minutes to several days. After processing at the loyalty database 102, the system 100 applies the business rules to the captured, received transactions to allocate and issue the reward points.

In this manner, the client considers both POS and electronic transactions of the customers 402 when awarding the reward points. In one embodiment, when merging the POS and electronics transactions of the customers 402, the customer identifier is created automatically on-line or assigned off-line (at a POS location such as the client store 404).

In an alternative embodiment, the system 100 is used in a club/association loyalty program. The club/association loyalty program enables celebrity and fan-related clients to identify, communicate with and add customer advocates via fan club and association websites. The loyalty database stores transactions such as the behavior of club members online, including access to online content, and offline. On the basis of these transactions, the club members earn rewards such as computer downloads of new music releases and special invitations to sneak preview events. The club/association loyalty program includes an online fan club shopping center and newsletters to club members. The customers enroll in the club/association loyalty program using a credit card. The customers select a level of relationship with the celebrity. Each level offers different benefits and privileges.

In view of the above, it will be seen that the several objects of the invention are achieved and other advantageous results attained.

As various changes could be made in the above constructions, products, and methods without departing from the scope of the invention, it is intended that all matter contained in the above description and shown in the accompanying drawings shall be interpreted as illustrative and not in a limiting sense.

What is claimed is:

1. A system for implementing a loyalty program, each said program having a client providing products and/or services, each said program having reward points redeemable for rewards, each said client having at least one customer with which the client desires to build a loyalty relationship, said system comprising:
an electronic transaction gathering system gathering electronic information relating to electronic transactions between the client and the customer;
an interface to a point-of-sale (POS) transaction gathering system gathering POS information relating to POS transactions between the client and the customer;
an issuance system issuing the reward points to the customer in response to the gathered electronic and POS information;
a database storing the gathered electronic and POS information and an amount of the issued reward points of each customer; and
a redemption request system allowing the customer to request redemption of the reward points for rewards.

2. The system of claim 1, further comprising a fulfillment system for fulfilling the redemption requests.

3. The system of claim 1, further comprising a collection of rewards from which each client selects rewards to be available to that client's customers for redemption.

4. The system of claim 1, further comprising a report system accessing the database to generate reports relating to the gathered electronic and POS transactions and redemptions.

5. The system of claim 4, wherein the reports include activity for each program or for each customer.

6. The system of claim 1, further comprising an allocation system for allocating an amount of the reward points to each customer according to business rules defined by the client.

7. The system of claim 6, wherein the issuance system issues the allocated amount of reward points to each customer.

8. The system of claim 6, wherein the business rules include one or more methods that define the allocation of the amount of the reward points to each customer.

9. The system of claim 8, wherein the methods include primary, secondary, and bonus methods.

10. The system of claim 9, wherein the primary method allocates an amount of the reward points to each customer when the customer interacts with the client.

11. The system of claim 9, wherein the secondary method allocates an amount of the reward points to each customer when the customer interacts with partners affiliated with the client.

12. The system of claim 9, wherein the bonus method allocates an amount of the reward points to each customer during promotions offered by the client or by partners affiliated with the client.

13. The system of claim 6, wherein the business rules include at least one point-to-dollar ratio representing the number of the reward points earned per monetary currency spent by the customer.

14. The system of claim 13, wherein the point-to-dollar ratio is one point for every dollar spent by the customer.

15. The system of claim 1, wherein the issuance system issues an amount of the reward points to each customer according to an allocation designated by the client.

16. The system of claim 1, further comprising a service representative system for allowing a service representative to access the redemption request system on behalf of the customers.

17. The system of claim 1, further comprising at least one batch file containing the gathered electronic and POS transactions, wherein the gathered electronic and POS transactions are entered into the database by a human operator accessing the batch file.

18. The system of claim 1, further comprising at least one batch file containing the gathered electronic and POS transactions, wherein the gathered electronic and POS transactions are entered into the database by a processor accessing the batch file.

19. The system of claim 1, further comprising a port through which customers access the redemption request system with a telecommunications device.

20. The system of claim 1, further comprising a graphic design presented to the customers, said graphic design includes one or more of the following: an enrollment solicitation, a welcome kit, a newsletter, or a progress report.

21. The system of claim 1, wherein the gathered electronic and POS transactions include one or more of the following: a purchase, achieving an anniversary date, completing a survey, selecting a banner advertisement, or transmitting an electronic mail message.

22. The system of claim 1, wherein the electronic transaction gathering system is a software program resident at a location associated with the client.

23. The system of claim 1, wherein the POS transaction gathering system is a business machine at a location associated with the client.

24. A method for implementing a loyalty program, each said program having a client providing products and/or services, each said program having reward points redeemable for rewards, each said client having at least one customer with which the client desires to build a loyalty relationship, said method comprising the steps of:
gathering electronic information relating to electronic transactions between the client and the customer;
gathering POS information relating to POS transactions between the client and the customer;
issuing the reward points to the customer in response to the gathered electronic and POS information;
storing the gathered electronic and POS information and an amount of the issued reward points of each customer; and
allowing the customer to request redemption of the reward points for rewards.

25. The method of claim 24, further comprising the step of gathering electronic information relating to electronic transactions between the customer and affiliated partners of the client.

26. The method of claim 24, further comprising the step of gathering POS information relating to POS transactions between the customer and affiliated partners of the client.

27. The method of claim 24, further comprising the step of reducing the amount of the reward points of each customer according to client preferences.

28. The method of claim 27, wherein the step of reducing includes the step of expiring the amount of the reward points of each customer according to at least one method.

29. The method of claim 24, further comprising the step of each client selecting rewards from a collection of rewards to be available to that client's customers for redemption.

30. The method of claim 24, further comprising the step of fulfilling the redemption requests.

31. The method of claim 30, further comprising the step of receiving shipping information for review by the redeeming customer.

32. The method of claim 24, further comprising the step of querying the database to target customers to receive communications.

33. The method of claim 24, further comprising the step of the supplier modifying one or more of the following: a graphic design, the rewards available to the customers, or business rules.

34. A system for implementing a loyalty program, each said program having a client providing products and/or services, each said program having reward points redeemable for rewards, each said client having at least one customer with which the client desires to build a loyalty relationship, said system comprising:
means for gathering electronic information relating to electronic transactions between the client and the customer;
means for gathering POS information relating to POS transactions between the client and the customer;
means for issuing the reward points to the customer in response to the gathered electronic information of said means for gathering electronic information and in response to the gathered POS information of said means for gathering POS information;
means for storing the gathered electronic and POS information and an amount of the issued reward points of each customer; and
means for allowing the customer to request redemption of the reward points for rewards.

35. A method for implementing a loyalty program, each said program having a client providing products and/or services, each said client having one or more customers with which the client desires to build a loyalty relationship, said method comprising the steps of:
gathering electronic information relating to electronic transactions between the client and the one or more customers;
gathering POS information relating to POS transactions between the client and the one or more customers;
storing the gathered electronic and POS information; and
identifying at least one specific customer from the one or more customers based on one or more criteria involving the gathered electronic information relating to electronic transactions between the client and the specific customer and the gathered POS information relating to POS transactions between the client and the specific customer.

36. The method of claim 35, further comprising the step of communicating with the identified customers via direct marketing.

37. The method of claim 35, wherein the electronic transactions and/or POS transactions include purchases associated with the customer.

38. The method of claim 38, wherein the electronic transactions include access by the customer to online content.
